(19) United States
(12) Patent Application Publication
(10) Pub. No.: US 2009/0319132 A1
(43) Pub. Date: Dec. 24, 2009

(54) Vehicle Speed Based Driving Control System with Single Operating Device

(76) Inventors: Yongzhi Qi, Jinzhou (CN); Yongping Qi, Fremont, CA (US)

Correspondence Address: Yongzhi Qi;c/o Yongping Qi, 3116 Baylis Street, Fremont, CA, 94538, US

(21) Appl. No.: 12/386,957

(22) Filed: Nov. 11, 2007

(51) Int. Cl. G05D 1/12

(52) U.S. Cl. 701/48

(57) ABSTRACT

A device which integrates conventional vehicle driving components (clutch, brake, gear-shifting, steering wheel and accelerator) into a single operating handle which reduces the need for space inside the vehicle and make driving easier. This is done through a controlled process involving load sensor, speed sensor, set speed, driven-by-ware and engine control unit. The set speed is the base input for the process and as a result, no more energy than necessary is consumed.

### BACKGROUND OF THE INVENTION

Since automobile came into being for one hundred years ago, it has been equipped with an accelerator pedal, a brake pedal, a gear lever, a clutch pedal (manual transmission) and a steering wheel. People need to put a lot of efforts in training and practicing to operate those components before becoming a qualified driver. But that will change with this invention: “A Vehicle-Speed Based Driving Control System with Single Operating Device”.

The goals of this invention are: first, to integrate all the driving devices in a fuel Powered vehicle into a single operating device; and second, to provide a solution to optimize the Engine Load and matching gear position to lower fuel consumption.

### BRIEF SUMMARY OF THE INVENTION

We usually have to operate these devices while driving a vehicle:
The Accelerator pedal
The Brake pedal
The Gear lever
The Clutch pedal (manual transmission)
The Steering wheel

To operate the five devices above, a driver usually needs to dedicate both hands and feet and as a result, it is not an easy task for a beginner driver.

Even though the Automatic Transmission takes away the burden of operating the clutch and gearbox from the driver, but at the same time the fuel consumption rises.

For a long time, it has only been a dream that a vehicle can be operated with a single handle, because all different control processes in existence simply cannot make it happen; the solution provided by this invention will make the dream come true.

### DETAILED DESCRIPTION OF THE INVENTION

The new design will replace the functions of the Accelerator pedal, brake pedal, gear lever, clutch pedal and even the steering wheel if desired by a single operation unit (for example, a single operation handle or a control consol), as a result a driver can operate the vehicle with just one hand instead of both hands and legs.

In the conventional automotive control process, the expected vehicle speed is obtained by operating the gears and the accelerator pedal; see FIG. 1.

While the new control process provided by this invention is a reversion of the conventional control process; or it can be considered as a “Vehicle-Speed Based Control Process” as illustrated in FIG. 2.

The new control process requires a Vehicle Speed Setting Device. It can be an electric signal generator with a handle which can be moved in one dimension within a slot. There are two braking triggers at both ends of the slot. If it is desired to substitute the traditional steering wheel, two side-inductors for the vehicle speed setting device can be used. A reversing lock is used for backing up the vehicle. See FIG. 3 for an illustrative diagram of the operating device which shows a handle and its scale, platform; there are two buttons on it, the handle's reversing lock button and the handle's braking button.

The comparator is a circuit in the Engine Control Unit (ECU)

An Engine rotating speed—Load—Gear position of automatic transmission table must be added to the ECU, so that it can send operating signals to both the automatic transmission and the throttle driven by Wire (DBW). The ECU will use this table to match the impedance for both the transmission and the power to achieve higher fuel efficiency.

To lower the cost, vehicle speed sensor can be replaced by a rotating rate sensor.

Here is the basic closed loop control process: setting expected vehicle speed, a differential signal generated from the comparator is sent to the ECU. The ECU outputs a trial DBW operating signal; and then uses the Load as a variable, the ECU outputs a Gear Position signal based on the Engine rotating speed—Load—Gear position of automatic transmission table in the ROM. These two signals will change the speed of the vehicle. The instantaneous Vehicle speed signal is then sent to the comparator for comparing with the expected vehicle speed again.

The advantages of this new design are:
(1) People would drive a vehicle with only one hand instead of both hands and legs. The simplified operations make it easier to drive a vehicle because there are fewer devices to operate.
(2) The single operating handle (or console) can be easily designed so that it can be configured by different drivers (including handicapped ones) to their own advantages.
(3) The new design will make the current Cruise Control System (CCS) obsolete because the vehicle speed is the controlling target, the fuel consumption is reduced at all different speeds.
(4) The new design provides a solution to optimize the engine load and its matching gear position in automatic transmission control; and reduce fuel consumption.
(5) The need for space in the driver's cab is reduced; and as a result the vehicle can be designed to be smaller, lighter in weight or to utilize the extra space for other purpose (safety, driving guidance . . . ).
(6) Since all the output from the Vehicle Speed Setting Device is the electrical signals, it is suitable for various kinds of transportation vehicles and devices, especially for mixed-power vehicles.
(7) Except for the ECU; almost all other existing auxiliary assemblies can remain unchanged.

### BRIEF DESCRIPTION OF THE DRAWINGS

FIG. 1 shows conventional automotive control process, in which the expected vehicle speed is obtained by operating the gears and the accelerator pedal.

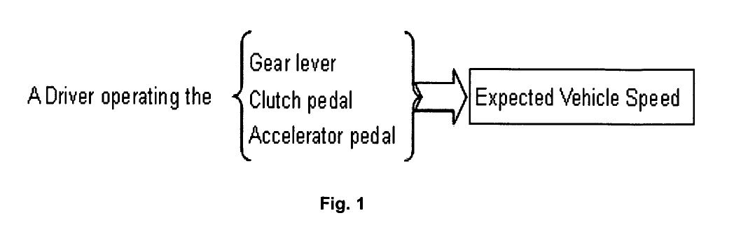

FIG. 2 shows the new control process provided by this invention which is a reversion of the conventional control process.

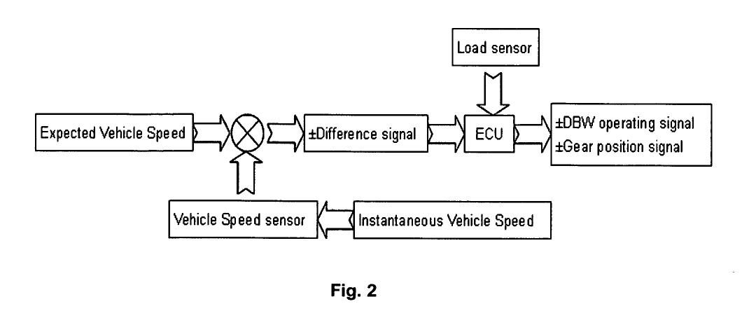

FIG. 3 illustrates the operating device used by this invention.

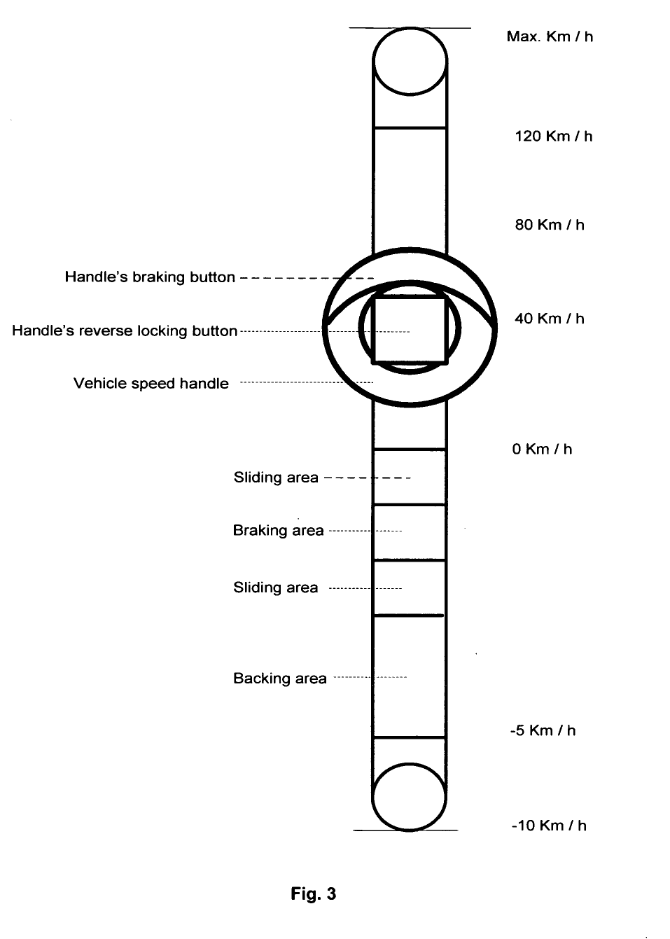

1. We claim a vehicle driving control device which compressing: a Load sensor means for detecting engine load, a vehicle speed sensor means for obtaining instantaneous vehicle speed, a comparison means for obtaining difference between vehicle speed and target speed, an operating parameter table stored in the Engine Control Unit for sending signals to transmission and throttle driven by wire, a closed loop control process for optimizing engine load and auto transmission control's gear position, an integration means for integrating conventional vehicle operating components into a single operating device.
